(19) United States
(12) Patent Application Publication
(10) Pub. No.: US 2006/0029630 A1
(43) Pub. Date: Feb. 9, 2006

(54) A Method for Admixing Plant Essential Oils to Coatings (Paints, Stains, etc) For the Purpose of Repelling Insects During Coating Application and Introducing an Insect Repellant Nature to the Cured or Dried Film

(75) Inventor: Gregg R. Overman, Southaven, MS (US)

Correspondence Address: Gregg R. Overman, 1760 Epping Forest Dr., Southaven, MS, 38671, US

(73) Assignee: Gregg R. Overman, Southaven, MS (US)

(21) Appl. No.: 11/161,339

(22) Filed: Jul. 29, 2005

Related U.S. Application Data
(60) Provisional application No. 60/600,124, filed on Aug. 9, 2004.

(51) Int. Cl. A01N 25/00

(52) U.S. Cl. 424/405

(57) ABSTRACT

The Federal EPA has consistently limited the use of known toxicants (insecticides) to preclude their admixture into paints and coatings by contractors or homeowners for the purpose of repelling or killing insects on the dried or cured coating. The current invention utilizes materials taken from the EPA's GRAS (Generally Recognized as Safe) List for this purpose. Furthermore, the current invention utilizes the insect repellant nature of these materials to repel insects from the area during coating application, thereby eliminating the need for topical insect repellants such as DEET.

### BACKGROUND ART

There are a limited number of products available today that use known insecticides to impart insecticidal properties to a dried paint film. In general these products are added to the paint prior to painting and are therefore incorporated into the dried or cured paint. Previously, Diazinon was used and marketed under the name “CPF2D,” but it's registration for this use was discontinued. Numerous other materials have been used in this application, including Dursban (Chlorpyrifos), but the Environmental Protection Agency (EPA) has consistently disallowed these applications presumably due to the inherent dangers of allowing consumers to admix known toxicants without training or instruction. Currently this inventor is aware of only one material being used for this purpose, i.e. a Deltamethrin product sold under the name “Bug Juice.” It may well be that this labeled use will be disallowed in the near future.

There are also many products available today to repel insects from a given area or to deter insects, especially mosquitoes, from contacting the skin. The most well-known of these materials is N,N-diethyl-meta-toluamide or N,N-diethly-3-methylbenzamide (DEET). This is the active ingredient in such products as OFF and many other commercially available insect repellants. It is well known that many plants produce compounds that are toxic or irritating to insects. Other plants may mimic the odor of these compounds to repel insects. There are many products made from plant oils being marketed today as insect repellants or insecticides.

### SUMMARY OF THE INVENTION

Various plant-derived essential oils have been used in numerous applications dating back to prehistory. In today's market there are a number of essential oils being marketed to repel insects or animals. Essential oils tend to be volatile and will evaporate quickly when exposed to the elements. In many cases these oils are dissolved in Mineral Oil both to lower the cost and extend the useable life of the essential oil after it has been applied and exposed to the elements. The Mineral Oil acts as a carrier and a binder in this case and will greatly slow the evaporation of the essential oils. It is desirable to impart insecticidal or insect repellant properties to dried paint films. This will stop or deter spiders, wasps, Carpenter Bees, and many other undesirable insects from crawling on, building nests on, or burrowing into the painted surface. There are products currently being marketed for admixture to paints for this purpose, but these materials are registered pesticides and are known to have significant toxicity in and of themselves.

This invention describes the use of plant oils and plant extracts of relatively low toxicity for the purpose of repelling or otherwise discouraging insects and arachnids from inhabiting painted surfaces. This is accomplished by simply mixing the proper oil into the bulk paint or coating prior to application. In this way, the oil is incorporated into the dried paint film where it will remain for extended periods of time.

Furthermore, the presence of the oils in the paint or stain will repel insects during the application of the paint or stain. This is quite different from the action of the available products which may function quite well to stop insects from nesting on the cured paint but which have no utility in repelling insects during the application of the coating.

### DETAILED DESCRIPTION OF THE INVENTION

Many plant oils and extracts are known to be effective as insecticides and/or insect repellants. The current invention consists of adding one or more plant oils or extracts to a bulk coating, mixing the coating well, and then applying the coating as per the manufactures directions.

This coating may be variously referred to as paint, stain, wood oil, wood finish, wood seal, wood protectant, rust preventive coating, etc. In general the coating will dry or cure via water loss in the case of latex coatings or via oxidative polymerization in the case of traditional alkyd (oil based) paints. However, there are any number of non-traditional coatings that could benefit from the current invention. These might include lacquers, asphaltic materials, penetrating wood oils, wood preservatives, water repellants, and many others. The sole criteria for usefulness being that the coating impart some solids to the substrate and thereby provide a material to retard the evaporation or degradation of the plant oil or plant extract.

The plant oils and extracts useful in this invention are numerous and varied. However, for the purposes of this invention, we shall consider materials of relatively low toxicity and known efficacy. It is also beneficial, from the standpoint of regulatory complexity, to choose oils, extracts and related compounds that are exempt from regulation by the Federal Insecticide Fungicide and Rodenticide Act (FIFRA). A list of these materials can be found in 40 CFR Part 152.25. This list of materials is deemed by the federal government to be “Generally Recognized as Safe” and is often referred to as the GRAS List. As of the writing of this document, the components of the GRAS List that might be useful are as follows:
Castor oil (U.S.P. or equivalent)
Cedar oil
Cinnamon and cinnamon oil
Citric acid
Citronella and Citronella oil
Cloves and clove oil
Eugenol
Garlic and garlic oil
Geraniol
Geranium oil
Lauryl sulfate
Lemongrass oil
Malic acid
Mint and mint oil
Peppermint and peppermint oil
2-Phenethyl propionate (2-phenylethyl propionate)
Potassium sorbate
Putrescent whole egg solids
Rosemary and rosemary oil
Sesame (includes ground sesame plant) and sesame oil
Thyme and thyme oil
White pepper

During practical application, one or more of these oils or extracts would be added to the coating at a rate of between 0.5 and 28 ounces of oil or extract per gallon of coating, not to exceed a total loading of 28 ounces per gallon and preferably at a rate of two to six ounces per gallon. The coating/oil or extract mixture would then be mixed thoroughly to incorporate the oil into the coating. The coating should be applied as per the manufacturer's directions.

The presence of the oil during application will deter wasps, mosquitoes and other noxious insects from inhabiting the area and will therefore take the place of personal insect repellants (such as DEET) which must be applied to the skin.

The resulting coating will also contain the oil or extract and will repel and deter insects and arachnids of all types from nesting, crawling, or burrowing into the treated surface.

At the lower levels of addition, there are no expected adverse effects on the dried or cured paint film from the addition of the oil or extract.

Experimental evidence using a “Preferred Box” type of testing has proven that insects will shun areas that have been painted with coatings containing Citronella, Cedar Wood Oil, Eugenol, Rosemary Oil and other materials from the GRAS List. The insects will preferentially inhabit the box painted with identical coatings but lacking the essential plant oil additives.

Tests have also been conducted in real life situations, and it has been observed that Carpenter Bees will vacate previously infected structures when these structures are painted with coatings containing the essential oils. Further observation of treated and untreated areas has shown a lack of spider webs, wasp nests, Lady Bug infestations, and other signs of insect activity in the treated areas even when nearly identical untreated areas showed normal insect activity.

Observation of the absence of mosquitoes and wasps during the application of test materials led to the claim that coatings treated with these oils would repel these nuisance insects even as painting is in progress. This will be a boon to painters who have normally resorted to long-sleeved shirts and various preparations containing DEET.

Various mixtures of these oils and extracts may be found to be synergistic in their activity or more active against a particular pest when blended together. In this case the invention might consist of blending the oils and extracts together and marketing the blend in this form for greater or more specific activity.

Having thus described the present invention, it is to be understood that the invention is not to be limited by particular details set forth in the above description as many apparent variations thereof are possible without departing from the spirit or scope thereof.

What is claimed is:

1. Admixture of essential plant oils found on the EPA's GRAS List and of relatively low toxicity to a paint, stain, or other coating will render the dried or cured film repellant to a broad spectrum of insects and arachnids.

2. Admixture of essential plant oils found on the EPA's GRAS List and of relatively low toxicity to a paint, stain, or other coating will repel noxious insects such as mosquitoes and wasps from the immediate area during the application of said paint, stain, or other coating.
